(19) United States
(12) Patent Application Publication
(10) Pub. No.: US 2021/0283995 A1
(43) Pub. Date: Sep. 16, 2021

(54) VEHICLE WINDSHIELD ROLLER SHADE

(71) Applicant: Michael McDermott, Las Vegas, NV (US)

(72) Inventor: Michael McDermott, Las Vegas, NV (US)

(21) Appl. No.: 17/198,249

(22) Filed: Mar. 11, 2021

Related U.S. Application Data
(60) Provisional application No. 63/100,466, filed on Mar. 16, 2020.

(51) Int. Cl. B60J 1/20

(52) U.S. Cl. CPC B60J 1/2063; B60J 1/2038; B60J 1/2077; B60J 1/2044; B60J 1/2047; B60J 1/2041

(57) ABSTRACT

A vehicle windshield roller shade including a roller shade assembly having a cylindrical casing, a U-shaped bracket, and a series of fasteners. The cylindrical casing houses a retractable shade hosted on a retractable coil. The U-shaped bracket is configured to be mounted along a vertical side of a windshield using semi-permanent fastening means and is configured to removably engage the cylindrical casing. The series of fasteners may be mounted on an interior surface of the windshield opposing the cylindrical casing and are configured to engage with and secure the retractable shade when the retractable shade is in an extended condition. The retractable shade blocks sunlight from entering a vehicle through its windshield and provides shading to an interior of the vehicle during use.

### CROSS-REFERENCE TO RELATED APPLICATION(S)

The present application is related to and claims priority to U.S. Provisional Patent Application No. 63/100,466 filed Mar. 16, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of sunshades of existing art and more specifically relates to a vehicle sunshade.

### RELATED ART

It is known that solar heat buildup in a closed automotive vehicle can cause the inside of the vehicle to reach extremely high temperatures. This heat can be damaging to the interior components and degrade the appearance of a vehicle. Additionally, the sun glaring through the windshield exacerbates the interior heat and figuratively ‘cooks’ the dash, steering wheel and other interior surfaces to the point where they eventually fade and crack. Various devices have been developed in the past with some degree of success. The modern trend is to use a foldable or accordion-style piece of material which may be positioned on the inside of the front windshield of the vehicle. However, it is difficult for one person to stretch these ordinary devices across a windshield and secure them in an upright position using the vehicle's visors. Another problem is people often store these typical sunshades in their back seat or floorboard, which can make them inconvenient to retrieve as well as result in damage. A suitable solution is desired.

U.S. Pat. No. 2002/0069980 to James Floyd relates to an adjustable-width roller shade configured to maintain orthogonal tracking at all available widths. The described adjustable-width roller shade configured to maintain orthogonal tracking at all available widths includes an adjustable-width spring-operated roller shade that maintains proper orthogonal tracking at all available widths within the shade's range of width adjustment. The adjustable-width roller shade utilizes two overlapping window shades and a telescoping roller to provide a shade that is repeatedly width-adjustable within its original range of width adjustment. To keep the shade sufficiently perpendicular to the roller as the shade winds onto the roller, orthogonal tracking spacers, such as continuous, pliable strips constructed from the same material as the shades, are attached to non-overlapped portions of the shade material to compensate for the extra layers of material existing at the overlapped portion of the shades. Thus, the roller shade maintains proper orthogonal tracking of the shade at all available widths within the shade's range of width adjustment.

### SUMMARY OF THE INVENTION

In view of the foregoing disadvantages inherent in the known vehicle sunshade art, the present disclosure provides a novel vehicle windshield roller shade. The general purpose of the present disclosure, which will be described subsequently in greater detail, is to provide an interior automobile shading system that is effective, convenient, easily mountable and simple to use.

A vehicle windshield roller shade is disclosed herein. The vehicle windshield roller shade includes a roller shade assembly including a cylindrical casing, a U-shaped bracket, and a series of fasteners. The cylindrical casing houses a retractable shade comprising a UV-resistant sheet hosted on a retractable coil. The retractable shade features a leading-edge bracket extending along a leading edge of the UV-resistant sheet. The U-shaped bracket configured to be mounted along a vertical side of a windshield using semi-permanent fastening means and is configured to removably engage the cylindrical casing. The series of fasteners may be mounted on an interior surface of the windshield opposing the cylindrical casing and are configured to engage with and secure the leading-edge bracket of the retractable shade when the retractable shade is in an extended condition. The retractable shade is sized and configured to cover the entire interior portion of a windshield of a vehicle during a fully extended, in-use condition. The vehicle windshield roller shade, as designed, provides interior automobile shading that is effective, convenient, easily mountable and simple to use.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicle windshield roller shade, constructed and operative according to the teachings of the present disclosure.

FIG. 1 is a perspective view of the vehicle windshield roller shade during an ‘in-use’ condition, according to an embodiment of the disclosure.

FIG. 2 is a perspective view of a kit of the vehicle windshield roller shade of FIG. 1, according to an embodiment of the present disclosure.

FIG. 3 is a perspective view of a cylindrical casing and a U-shaped bracket of the vehicle windshield roller shade of FIG. 1, according to an embodiment of the present disclosure.

FIG. 4 is a perspective view of the cylindrical casing of the vehicle windshield roller shade of FIG. 1, according to an embodiment of the present disclosure.

FIG. 5 is a perspective view of a wand of the vehicle windshield roller shade of FIG. 1, according to an embodiment of the present disclosure.

FIG. 6A is a flow diagram illustrating a method for using a vehicle windshield roller shade 100, according to an embodiment of the present disclosure

FIG. 6B is a perspective view of the vehicle windshield roller shade during an ‘in-use’ condition, according to an embodiment of the disclosure.

FIG. 7A is a perspective view of a U-shaped bracket of the vehicle windshield roller shade of FIG. 1, according to an embodiment of the present disclosure.

FIG. 7B is a perspective view of one of a series of fasteners of the vehicle windshield roller shade of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle sunshade and more particularly to a vehicle windshield roller shade as used to improve interior automobile shading.

Generally, the vehicle windshield roller shade includes a retractable shade which blocks sunlight from entering a vehicle through its windshield and provides shading to an interior of the vehicle during use. The vehicle windshield roller shade includes a roller shade assembly comprising a cylindrical casing housing a retractable shade comprising a UV-resistant sheet hosted on a retractable coil, a U-shaped bracket, and a series of fasteners. The U-shaped bracket may be installed on a right edge, interior side of a vehicle's windshield and the series of fasteners may be secured directly on the interior surface of the windshield opposite the U-shaped bracket. The cylindrical casing is removably-engageable with the U-shaped bracket. The UV-resistant sheet may be extended from the cylindrical casing by pulling on a leading edge of the UV-resistant sheet extending through a slit of the cylindrical casing. The leading edge of the UV-resistant sheet comprises a leading-edge bracket which is configured to engage with the series of fasteners in order to secure the retractable shade in an extended condition. The cylindrical casing of the vehicle windshield roller shade may be of spring-return format or any other type that retracts the shade when it is not attached to the series of fasteners. The UV-resistant sheet features a notch along its upper length hem to accommodate a rearview mirror of the vehicle. Additionally, a telescoping wand may be provided for assisting a user with gripping and extending the retractable shade.

The retractable shade of the vehicle windshield roller shade may be made of various materials, such as but not limited to vinyl, polyester, cotton, polyethylene terephthalate (PET), woven fiberglass and any blend of these and/or other materials. The retractable shade of the vehicle windshield roller shade may include a coating, and the coating may be of materials such as but not limited to polyvinyl chloride (PVC) or other ultraviolet (UV) resistant materials. The cylindrical casing and series of fasteners of the vehicle windshield roller shade may be of various lightweight materials, such as but not limited to polyethylene terephthalate (PET) and polyvinylidene fluoride (PVDF). The wand of the vehicle windshield roller shade may be made in various sizes, and may be made of various materials, including but not limited to polyvinyl chloride (PVC), high-density polyethylene (HDPE) and aluminum. The wand may or may not be telescoping. The vehicle windshield roller shade may use various adhesives of required bonding capacity. The vehicle windshield roller shade may also be made in variations in which the bracket and clips are mounted by other means.

A method of using the vehicle windshield roller shade may be as follows: a user may install the vehicle windshield roller shade by applying durable, bonding adhesive upon a rear section of the U-shaped bracket and securing the U-shaped bracket upon an interior vertical edge of a windshield on a passenger side of a vehicle. The cylindrical casing may then be applied to the U-shaped bracket. The series of fasteners may then be applied in the same format, and evenly spaced, upon an opposite vertical wall of the windshield. To withdraw the retractable shade, the user may simply use the wand to grasp the leading edge of the retractable shade. The user may then pull the wand to withdraw the retractable shade, and then attach the retractable shade to the series of fasteners.

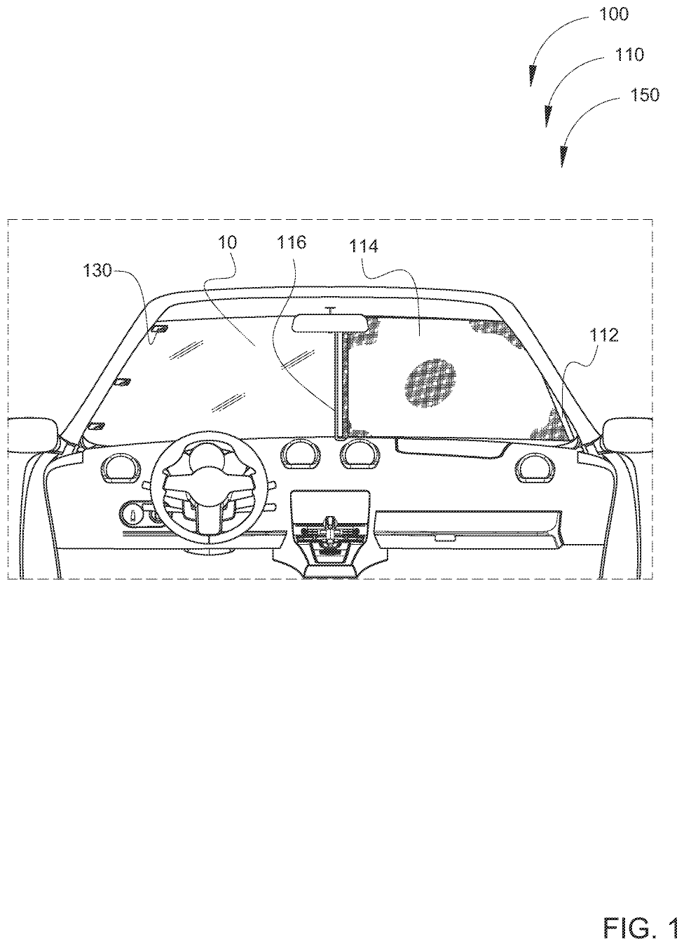

Referring now more specifically to the drawings by numerals of reference, there is shown in FIGS. 1-7B, various views of a vehicle windshield roller shade 100.

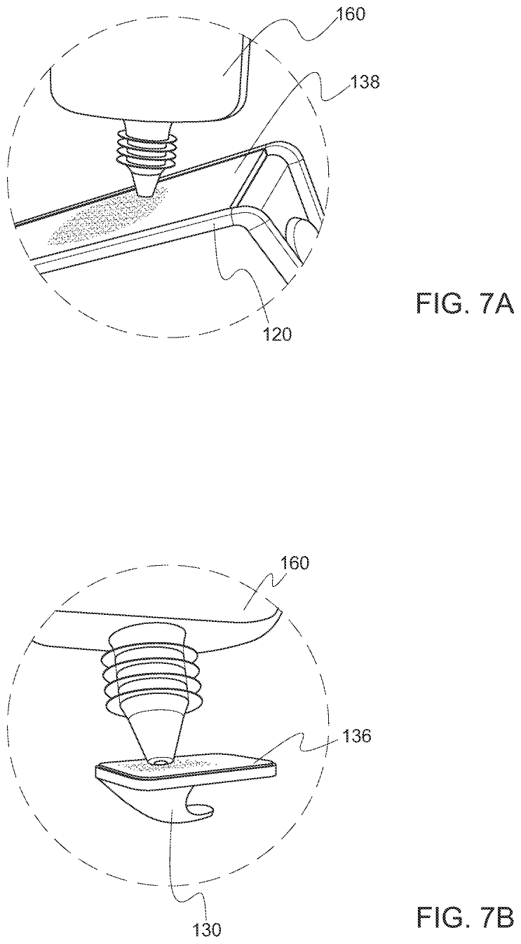

FIG. 1 shows a vehicle windshield roller shade 100 during an ‘in-use’ condition 150, according to an embodiment of the present disclosure. As illustrated, the vehicle windshield roller shade 100 may include a roller shade assembly 110 including a cylindrical casing 112, a U-shaped bracket 120, and a series of fasteners 130. The cylindrical casing 112 houses a retractable shade 114 comprising a UV-resistant sheet hosted on a retractable coil. The retractable shade 114 features a leading-edge bracket 116 extending along a leading edge of the UV-resistant sheet. The U-shaped bracket 120 is configured to be mounted along a vertical side of a windshield 10 using semi-permanent fastening means 160 and is configured to removably engage the cylindrical casing 112. The series of fasteners 130 preferably include three clips having a metal rear plane 136, as shown in FIG. 7B. The U-shaped bracket 120 includes a bracket metal rear plane 138, as shown in FIG. 7A.

The series of fasteners 130 may be semi-permanently installed using an adhesive on an interior surface of the windshield 10 opposing the cylindrical casing 112. The series of fasteners 130 are configured to engage with and secure the leading-edge bracket 116 of the retractable shade 114 when the retractable shade 114 is in an extended condition. The retractable shade 114 is sized and configured to cover an entire interior portion of the windshield 10 of a vehicle during a fully extended, in-use condition. The vehicle windshield roller shade 100 provides interior automobile shading that is effective, convenient, easily mountable and simple to use.

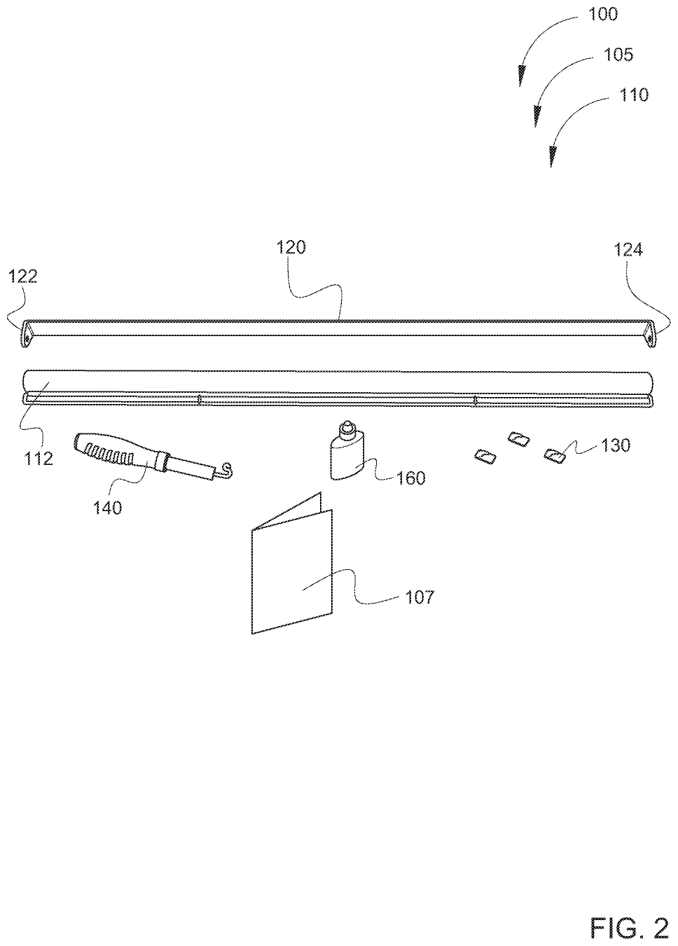

FIG. 2 shows the vehicle windshield roller shade 100 of FIG. 1, according to an embodiment of the present disclosure. According to one embodiment, the vehicle windshield roller shade 100 may be arranged as a kit 105. In particular, the vehicle windshield roller shade 100 may further include a set of instructions 107 and bonding adhesives or other suitable fastening means. The instructions 107 may detail functional relationships in relation to the structure of the vehicle windshield roller shade 100 such that the vehicle windshield roller shade 100 can be used, maintained, or the like, in a preferred manner.

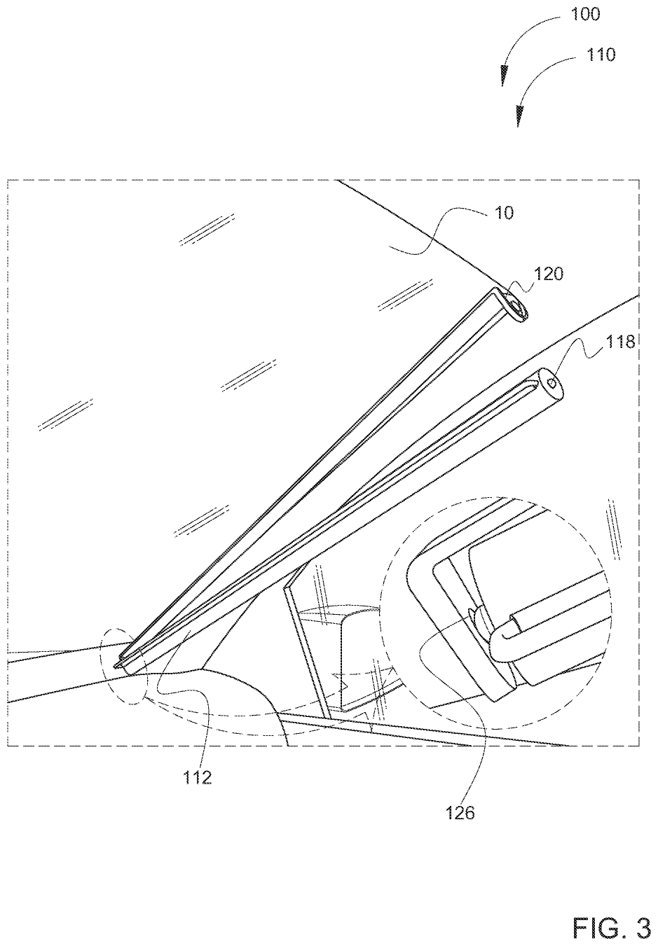

FIG. 3 is a perspective view of the vehicle windshield roller shade 100 of FIG. 1, according to an embodiment of the present disclosure. As shown, the U-shaped bracket 120 is semi-permanently installed on a passenger-side of the vehicle. The series of fasteners 130 are semi-permanently installed on a driver's-side of the vehicle along the interior surface of the windshield 10. The U-shaped bracket 120 comprises a first-tab 122 and a second-tab 124 each comprising an indentation 126 along an inner surface of the first-tab 122 and the second-tab 124. The cylindrical casing 112 comprises nodules 118 positioned at opposing ends of the cylindrical casing 112. The nodules 118 are configured to removably engage with the indentations 126 of the first-tab 122 and the second-tab 124 respectively.

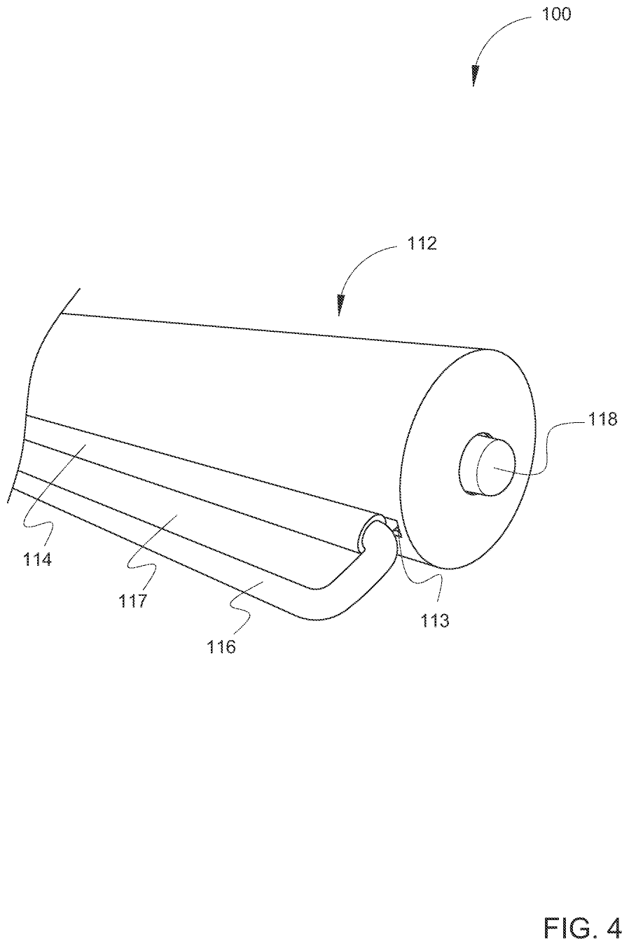

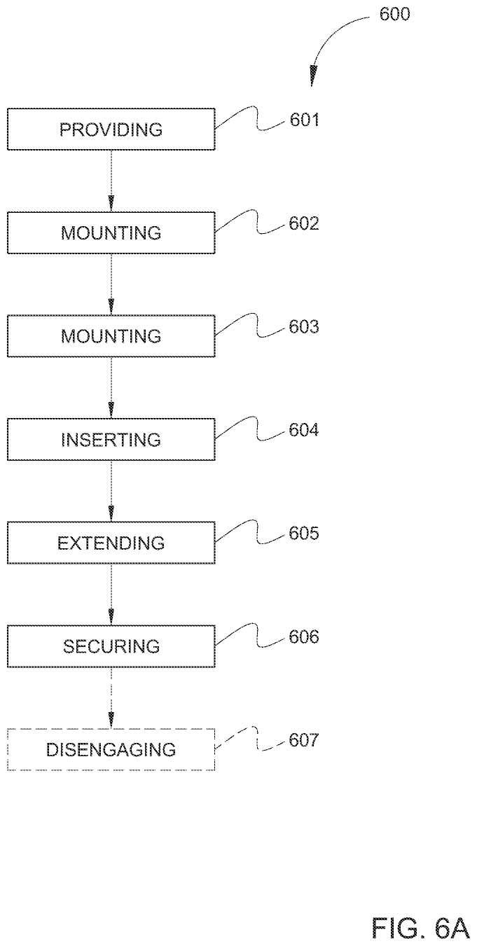

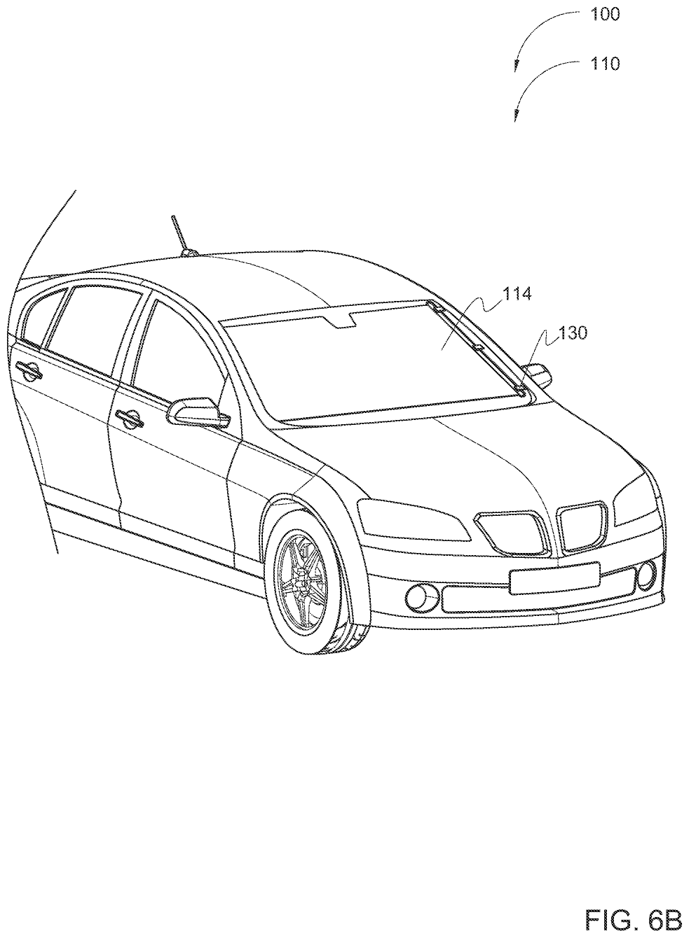

FIG. 4 is a perspective view of the cylindrical casing 112 of the vehicle windshield roller shade 100 of FIG. 1, according to an embodiment of the present disclosure. The retractable shade 114 is hosted in a rolled-format within the cylindrical casing 112 with the leading edge extending through a slit 113 of the cylindrical casing 112. The leading-edge bracket 116 includes an elongated profile and an open channel 117. In a preferred embodiment, the retractable shade 114 includes a notch configured to accommodate a rearview mirror of the vehicle, as shown in FIG. 6B. The UV-resistant sheet of the vehicle windshield roller shade 100 may be made of a vinyl, and in length and width to accommodate full or near-full covering of a windshield 10.

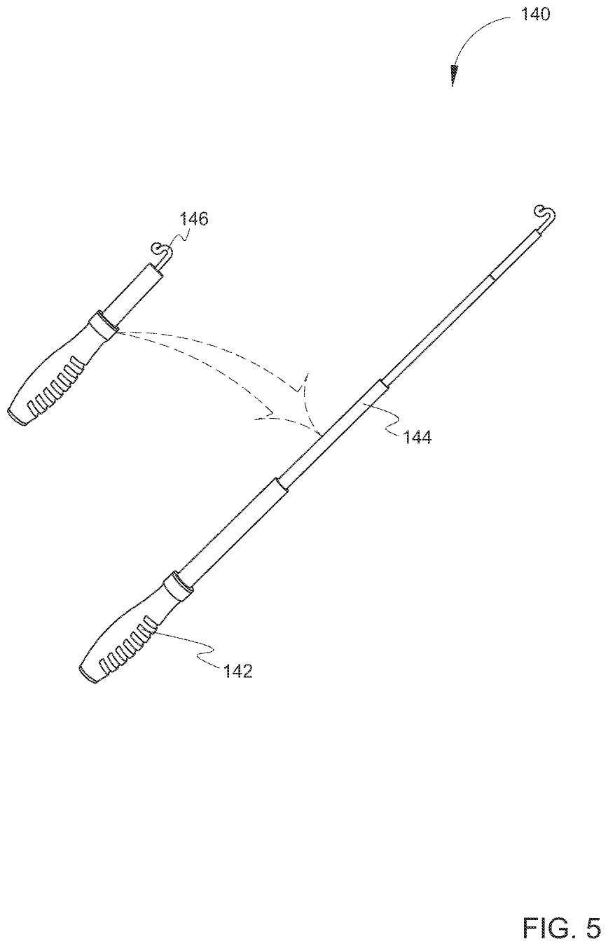

As shown in FIG. 5, the vehicle windshield roller shade 100 may further include a wand 140. The wand 140 is configured to assist a user when reaching over and extending the retractable shade 114. The wand 140 comprises a handle 142, a telescopic shaft 144, and a hook 146 opposing the handle 142. In a preferred embodiment, the wand 140 is telescopic. Using the included wand 140, the retractable shade 114 can be extended from the cylindrical casing 112 and pulled to an opposite vertical side of a windshield 10, where the retractable shade 114 can be attached to the series of fasteners 130, thus completing its shading of the entire windshield 10.

FIG. 6A is a flow diagram illustrating a method for using a vehicle windshield roller shade 100, according to an embodiment of the present disclosure. In particular, the method for using a vehicle windshield roller shade 600 may include one or more components or features of the vehicle windshield roller shade 100 as described above. As illustrated, the method for using a vehicle windshield roller shade 600 may include the steps of: step one 601, providing a roller shade assembly including a cylindrical casing 112 housing a retractable shade 114 comprising a UV-resistant sheet hosted on a retractable coil, a U-shaped bracket 120, and a series of fasteners 130; step two 602, mounting the U-shaped bracket 120; step three 603, mounting the series of fasteners 130; step four 604, inserting and mounting the cylindrical casing 112 within the U-shaped bracket 120; step five 605, extending the retractable shade 114; step six 606, securing the retractable shade 114 to the series of fasteners 130 using the leading edge bracket 116; and step seven 607, disengaging the retractable shade 114 from the series of fasteners 130.

It should be noted that step seven 607 is an optional step and may not be implemented in all cases. Optional steps of method of use 600 are illustrated using dotted lines in FIG. 6A so as to distinguish them from the other steps of method of use 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a vehicle windshield roller shade, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle windshield roller shade, the vehicle windshield roller shade comprising:
a roller shade assembly including,
a cylindrical casing housing a retractable shade comprising a UV-resistant sheet hosted on a retractable coil, said retractable shade including a leading-edge bracket extending along a leading edge of said UV-resistant sheet,
a U-shaped bracket configured to be mounted along a vertical side of a windshield using semi-permanent fastening means, said U-shaped bracket is configured to removably engage said cylindrical casing, and
a series of fasteners mounted on an interior surface of said windshield opposing said cylindrical casing and being configured to engage with and secure said leading-edge bracket of said retractable shade when said retractable shade is in an extended condition.

2. The vehicle windshield roller shade of claim 1, wherein said U-shaped bracket comprises a first-tab and a second-tab each comprising an indentation along an inner surface of said first-tab and said second-tab.

3. The vehicle windshield roller shade of claim 2, wherein said cylindrical casing comprises nodules positioned at opposing ends of said cylindrical casing, said nodules are configured to removably engage with said indentations of said first-tab and said second-tab respectively.

4. The vehicle windshield roller shade of claim 1, wherein said retractable shade is hosted in a rolled-format within said cylindrical casing with said leading edge extending through a slit of said cylindrical casing.

5. The vehicle windshield roller shade of claim 1, wherein said leading-edge bracket includes an elongated profile and an open channel.

6. The vehicle windshield roller shade of claim 1, wherein said retractable shade is sized and configured to cover an entire interior portion of said windshield of a vehicle during a fully extended, in-use condition.

7. The vehicle windshield roller shade of claim 6, wherein said retractable shade includes a notch configured to accommodate a rearview mirror of said vehicle.

8. The vehicle windshield roller shade of claim 1, wherein said U-shaped bracket is semi-permanently installed on a passenger-side of said vehicle.

9. The vehicle windshield roller shade of claim 8, wherein said series of fasteners are semi-permanently installed on a driver's-side of said vehicle along said interior surface of said windshield.

10. The vehicle windshield roller shade of claim 9, wherein said series of fasteners comprise clips.

11. The vehicle windshield roller shade of claim 10, wherein said clips each include a metal rear plane.

12. The vehicle windshield roller shade of claim 9, wherein said series of fasteners are semi-permanently installed using an adhesive.

13. The vehicle windshield roller shade of claim 1, wherein said semi-permanent fastening means includes a bonding adhesive.

14. The vehicle windshield roller shade of claim 1, further includes a wand configured to assist a user when extending said retractable shade.

15. The vehicle windshield roller shade of claim 14, wherein said wand is telescopic.

16. The vehicle windshield roller shade of claim 15, wherein said wand comprises a handle, a telescopic shaft, and a hook opposing said handle.

17. A vehicle windshield roller shade, said vehicle windshield roller shade comprising:
a roller shade assembly including,
a cylindrical casing housing a retractable shade comprising a UV-resistant sheet hosted on a retractable coil, said retractable shade including a leading-edge bracket extending along a leading edge of said UV-resistant sheet,
a U-shaped bracket configured to be mounted along a vertical side of a windshield using semi-permanent fastening means, said U-shaped bracket is configured to removably engage said cylindrical casing,
a series of fasteners mounted on an interior surface of said windshield opposing said cylindrical casing and being configured to engage with and secure said leading-edge bracket of said retractable shade when said retractable shade is in an extended condition, and
a wand configured to assist a user when extending said retractable shade,
wherein said U-shaped bracket comprises a first-tab and a second-tab each comprising an indentation along an inner surface of said first-tab and said second-tab;
wherein said cylindrical casing comprises nodules positioned at opposing ends of said cylindrical casing, said nodules are configured to removably engage with said indentations of said first-tab and said second-tab respectively;
wherein said retractable shade is hosted in a rolled-format within said cylindrical casing with said leading edge extending through a slit of said cylindrical casing;
wherein said leading-edge bracket includes an elongated profile and an open channel;
wherein said retractable shade is sized and configured to cover an entire interior portion of said windshield of a vehicle during a fully extended, in-use condition;
wherein said retractable shade includes a notch configured to accommodate a rearview mirror of said vehicle;
wherein said U-shaped bracket is semi-permanently installed on a passenger-side of said vehicle;
wherein said series of fasteners are semi-permanently installed on a driver's-side of said vehicle along said interior surface of said windshield;
wherein said series of fasteners comprise clips;
wherein said clips each include a metal rear plane;
wherein said series of fasteners are semi-permanently installed using an adhesive; and
wherein said semi-permanent fastening means includes a bonding adhesive.

18. The vehicle windshield roller shade of claim 17, further comprising a set of instructions, and
wherein the vehicle windshield roller shade is arranged as a kit.

19. A method of using a vehicle windshield roller shade, the method comprising the steps of:
providing a roller shade assembly including a cylindrical casing housing a retractable shade comprising a UV-resistant sheet hosted on a retractable coil, said retractable shade including a leading-edge bracket extending along a leading edge of said UV-resistant sheet,
a U-shaped bracket configured to be mounted along a vertical side of a windshield using semi-permanent fastening means, said U-shaped bracket is configured to removably engage said cylindrical casing, and
a series of fasteners mounted on an interior surface of said windshield opposing said cylindrical casing and being configured to engage with and secure said leading edge bracket of said retractable shade when said retractable shade is in an extended condition,
mounting said U-shaped bracket;
mounting said series of fasteners;
inserting and mounting said cylindrical casing within said U-shaped bracket;
extending said retractable shade; and
securing said retractable shade to said series of fasteners using said leading-edge bracket.

20. The method of claim 19, further comprising the steps of:
disengaging said retractable shade from said series of fasteners.
